(19) United States
(12) Patent Application Publication
(10) Pub. No.: US 2012/0206046 A1
(43) Pub. Date: Aug. 16, 2012

(54) Laser module

(76) Inventors: Chao-Chi Huang, (US); Tony K.T. Chen, (US); Chiang-Chiag Chen, (US)

(21) Appl. No.: 12/931,954

(22) Filed: Feb. 14, 2011

(51) Int. Cl. H01J 7/24; G02B 27/20

(52) U.S. Cl. 315/118; 362/259

(57) ABSTRACT

A laser module capable of being connected onto a circuit board includes a main body having a front opening, a rear opening, and an inner wall, a focusing lens connected in the front opening, a housing mounted to the exterior of the main body and enclosing the main body, with one end of the housing corresponding to the focusing lens having a through hole and the other end having an opening to accommodate the insertion of the main body into the housing. The laser module also includes a laser diode press-fitted onto the inner wall of the main body from the rear opening of the main body and aligned with the focusing lens as well as electrically connected to the circuit board, an image lens aligned with the focusing lens, an air-tight structure to seal the image lens inside the housing, a temperature sensor positioned under the laser diode as well as disposed on and electrically connected with the circuit board, and a temperature control plate positioned under the laser diode and the temperature sensor as well as disposed in the rear opening of the main body.

### BACKGROUND OF THE INVENTION

1. Field of the Invention

The present invention relates to a laser module, and in particular, a moisture-proof laser module which has an image lens is sealed therein within an air-tight structure.

2. Description of the Related Art

Conventional laser modules usually have a front housing disposed with a focusing lens and a rear housing disposed with a laser diode. An image lens is usually positioned in the front housings so that the beam projected by the laser diode can form a specific image through the image lens. Unfortunately, water vapour cannot be effectively prevented from penetrating into the laser module, so the image lens gradually becomes misty, thereby compromising the performance of the laser module. Furthermore, the working temperature of the laser diode cannot be effectively detected.

Consequently, the present invention employs an air-tight structure to tightly seal the front and rear housings which secure the laser diode and the image lens, so as to prevent water vapour from penetrating the laser module. A temperature sensor and a temperature control plate are also disposed under the laser diode to detect the working temperature of the laser diode. In addition, a photodiode can be employed to further enhance the accuracy of the temperature control and wavelength of the laser Diode.

### SUMMARY OF THE INVENTION

It is an object of the present invention to provide a laser module having an air-tight structure to prevent water vapor from reaching an image lens in the laser module.

It is another object of the present invention to provide a laser module that has a temperature sensor to detect the working temperature of the laser diode.

It is yet another object of the present invention to provide a laser module having a temperature control plate to maintain the laser diode at a constant temperature.

It is a further object of the present invention to provide a laser module with a photodiode to detect the optical power of the laser diode.

In order to accomplish the objects of the present invention, a laser module capable of being connected onto a circuit board includes a main body having a front opening, a rear opening, and an inner wall, a focusing lens connected in the front opening, a housing mounted to the exterior of the main body and enclosing the main body, with one end of the housing corresponding to the focusing lens having a through hole and the other end having an opening to accommodate the insertion of the main body into the housing. The laser module also includes a laser diode press-fitted onto the inner wall of the main body from the rear opening of the main body and aligned with the focusing lens as well as electrically connected to the circuit board, an image lens aligned with the focusing lens, an air-tight structure to seal the image lens inside the housing, a temperature sensor positioned under the laser diode as well as disposed on and electrically connected with the circuit board, and a temperature control plate positioned under the laser diode and the temperature sensor as well as disposed in the rear opening of the main body.

### BRIEF DESCRIPTION OF THE DRAWINGS

FIG. 1 is an exploded illustration of a laser module according to a first embodiment of the present invention;

FIG. 2A is an assembled perspective view of the laser module according to the first embodiment of the present invention;

FIG. 2B is a cross-sectional view of the laser module according to the first embodiment of the present invention;

FIG. 2C is a bottom plan view of the temperature sensor of the laser module according to the first embodiment of the present invention;

FIG. 3 is an exploded illustration of the laser module according to a second embodiment of the present invention;

FIG. 4A is an assembled perspective view of the laser module according to the second embodiment of the present invention;

FIG. 4B is a cross-sectional view of the laser module according to the second embodiment of the present invention;

FIG. 5 is an exploded illustration of the laser module according to a third embodiment of the present invention;

FIG. 6A is an assembled perspective view of the laser module according to the third embodiment of the present invention;

FIG. 6B is a cross-sectional view of the laser module according to the third embodiment of the present invention; and

FIG. 7 is an exploded illustration of the laser module according to a fourth embodiment of the present invention.

### DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

To clearly illustrate the laser module according to the present invention, descriptions will be accompanied with schematic figures.

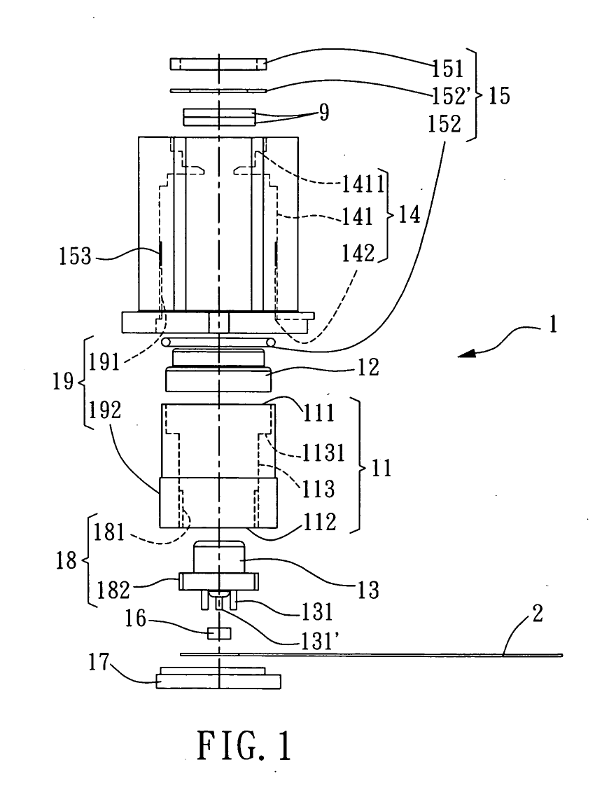

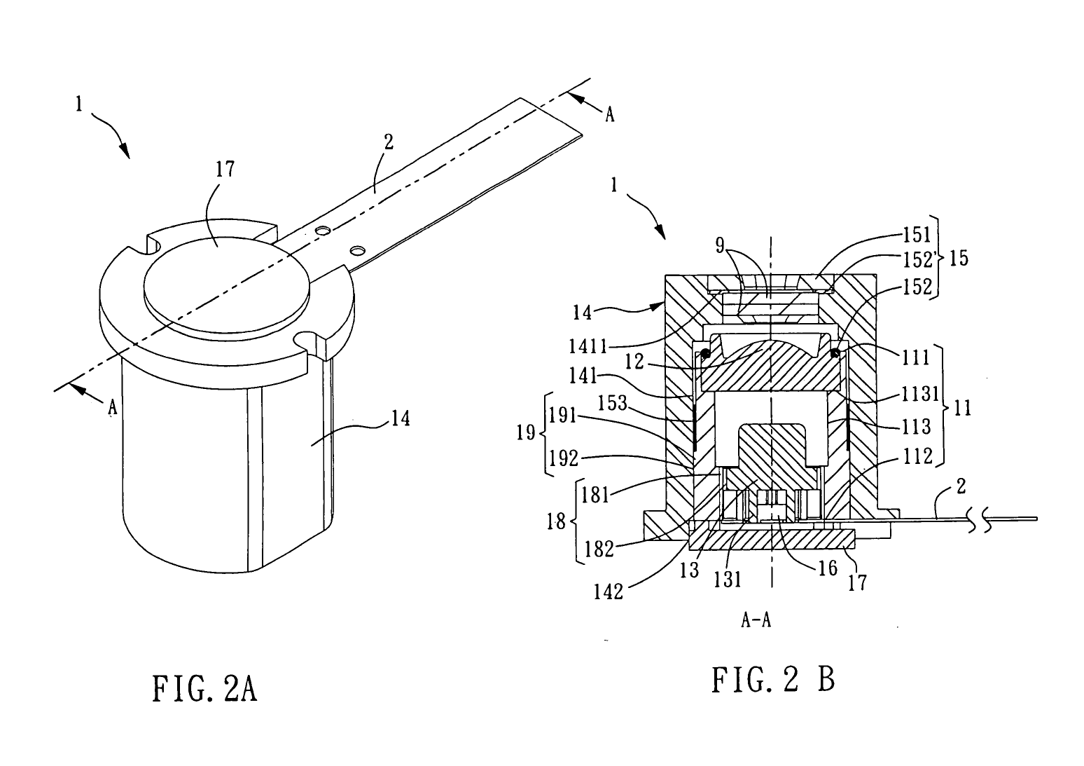

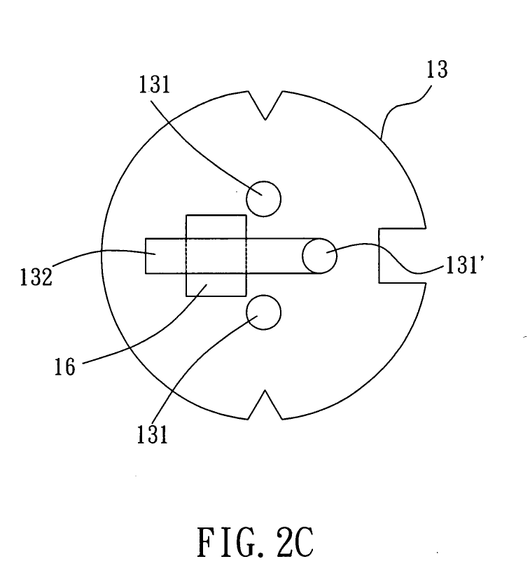

FIGS. 1, 2A, 2B, and 2C illustrate a laser module 1 according to a first embodiment of the present invention. The laser module 1 is electrically connected to a circuit board 2, which can be a thin-film circuit board in this embodiment. The laser module 1 includes a cylindrical main body 11, a focusing lens 12, a laser diode 13, a housing 14, an air-tight structure 15, a temperature sensor 16, a temperature control plate 17, and an image lens 9.

The main body 11 has a front opening 111, a rear opening 112, and an inner wall 113 that defines a cylindrical bore. A concave step 1131 is disposed on the inner wall 113 adjacent to the front opening 111. In the first embodiment of the present invention, the main body 11 can be made of metal to enhance the heat dissipation of the laser diode 13.

The air-tight structure 15 is provided to prevent water vapour from penetrating into the laser module 1 and thereby affecting the projecting performance of the image lens 9. The air-tight structure 15 includes a clamp ring 151, a plurality of rubber seal rings 152 and 152′, and an end seal 153.

The focusing lens 12 is secured to the concave step 1131 on the front opening 111 of the main body 11, and the rubber seal ring 152 is employed to further seal the gap between the focusing lens 12 and the concave step 1131 on the main body 11. From the rear opening 112 of the main body 11, the laser diode 13 is press-fitted into the inner wall 113 of the main body 11 and positioned to be aligned with the focusing lens 12. The laser diode 13 is electrically connected to the circuit board 2 through a plurality of conductive leads 131, 131′. Focusing calibration of the laser diode 13 can be carried out simultaneously as the laser diode 13 is gradually pushed into the inner wall 113 of the main body 11 for connection. As soon as the laser diode 13 reaches the accurate focus zone, the pushing of the laser diode 13 can be stopped. Since the laser diode 13 is press-fitted with the inner wall 113 of the main body 11, the laser diode 13 can be fixedly positioned to maintain accurate focusing thereafter.

The housing 14 is cylindrically-shaped and encloses the main body 11 in a secure mounting attachment. The end of the housing 14 that corresponds to the focusing lens 12 has a through hole 141, which in turn has a latching edge 1411 for receiving the image lens 9 to be connected therein. The other end of the housing 14 has another opening 142 to accommodate the insertion of the main body 11 into the housing 14. In the first embodiment of the present invention, the housing 14 can be made of heat-insulating plastics.

The image lens 9 is disposed in the through hole 141, and the rubber seal ring 152 is employed to seal the gap between the focusing lens 12 and the main body 11. Further, the clamp ring 151 is employed to clamp another rubber seal ring 152′ and the image lens 9 onto the latching edge 1411. The end seal 153 covers the gap between the external surface of the main body 11 and the inner surface of the housing 14. Consequently, the image lens 9 is sealed inside the housing 14 and is correspondingly positioned in front of the focusing lens 12. The laser beam projected from the laser diode 13 travels through the image lens 9 to form a predetermined image which is subsequently projected outwardly. The image lens 9 can be either a diffraction optical element (DOE) or a holographic optical element (HOD).

Referring to FIG. 2C, the laser diode 13 has a plurality of conductive leads 131 and 131′ which are electrically connected to the circuit board 2, with the conductive lead 131′ connected with the casing of the laser diode 13 extending to form a copper pad 132 along the base of the laser diode 13. Further, the temperature sensor 16 straddles the copper pad 132 to be electrically connected to the circuit board 2, so as to detect the temperature of the copper pad 132 and further adjust the working temperature of the laser diode 13 through the temperature control plate 17. The temperature detected by the temperature sensor 16 is therefore closer to that of the laser diode 13, and thus the temperature control of the laser module 1 will be more accurate.

In the first embodiment of the present invention, the temperature control plate 17 is a thermoelectric cooler, which is positioned under the laser diode 13, the temperature sensor 16, and the circuit board 2 as well as disposed in the opening 142 of the housing 14. The temperature control plate 17 is further coupled to the rear opening 112 of the main body 11 so as to control the temperature of the laser diode 13. Consequently, the temperature control plate 17 incorporated with the temperature sensor 16 can control the working temperature of the laser diode 13 more accurately. Also, the temperature control plate 17 has good heat conducting capacity so the temperature difference can be kept small and the operational life of the laser diode 13 can be extended.

A fitting structure 18 includes a protruding rib 181 and a guide 182, which are formed at the inner wall 113 of the main body 11 and the exterior of the laser diode 13, respectively. In the first embodiment of the present invention, the protruding rib 181 is disposed on the inner wall 113 of the main body 11, and the guide 182 is correspondingly formed at the exterior of the laser diode 13 to the protruding rib 181. When the laser diode 13 is being press-fitted into the main body 11, the protruding rib 181 is slid into the guide 182. The guide 182 can be moved axially with respect to the main body 11. Furthermore, because the fitting structure 18 is aligned axially with the main body 11, the insertion of the laser diode 13 into the main body 11 causes no inclination or rotation, thereby assuring accurate alignment and focus of the laser diode 13.

The exterior of the main body 11 and the inner edge of the through hole 141 of the housing 14 are provided with another corresponding fitting structure 19, which includes a guide 191 and a protruding rib 192. The guide 191 is disposed on the inner edge of the through hole 141 of the housing 14, and the protruding rib 192 is disposed along the exterior of the main body 11. When the main body 11 and the housing 14 is being connected, the protruding rib 192 on the exterior of the main body 11 is inserted into the guide 191 on the housing 14 and moved axially such that the main body 11 can be inserted into and press-fitted into the through hole 141 of the housing 14. Further, the image lens 9 disposed on the housing 14 can be positioned over the focusing lens 12 and also along the path of the laser beam projected from the laser diode 13.

In the following embodiments of the present invention, most of the elements are identical to or similar with those of the first embodiment of the present invention. As a result, the same elements in each of the embodiments will carry the same numeral designation, except that an alphabet (e.g., a, b, c) will be added to the numerical designation used in the first embodiment. No further description of these elements will be provided as these elements will be otherwise be the same as the corresponding element in the first embodiment.

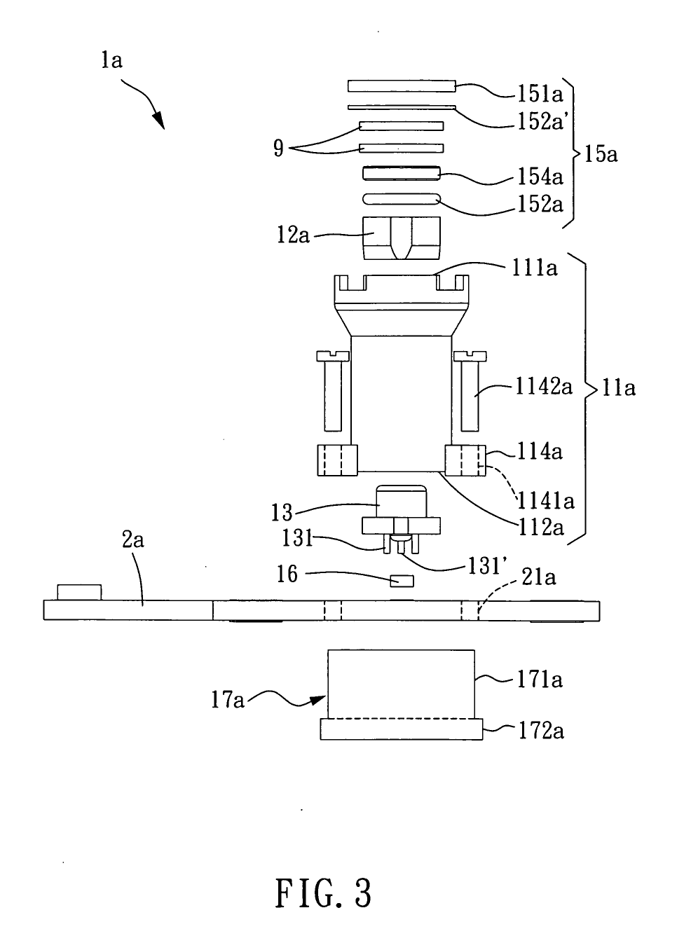

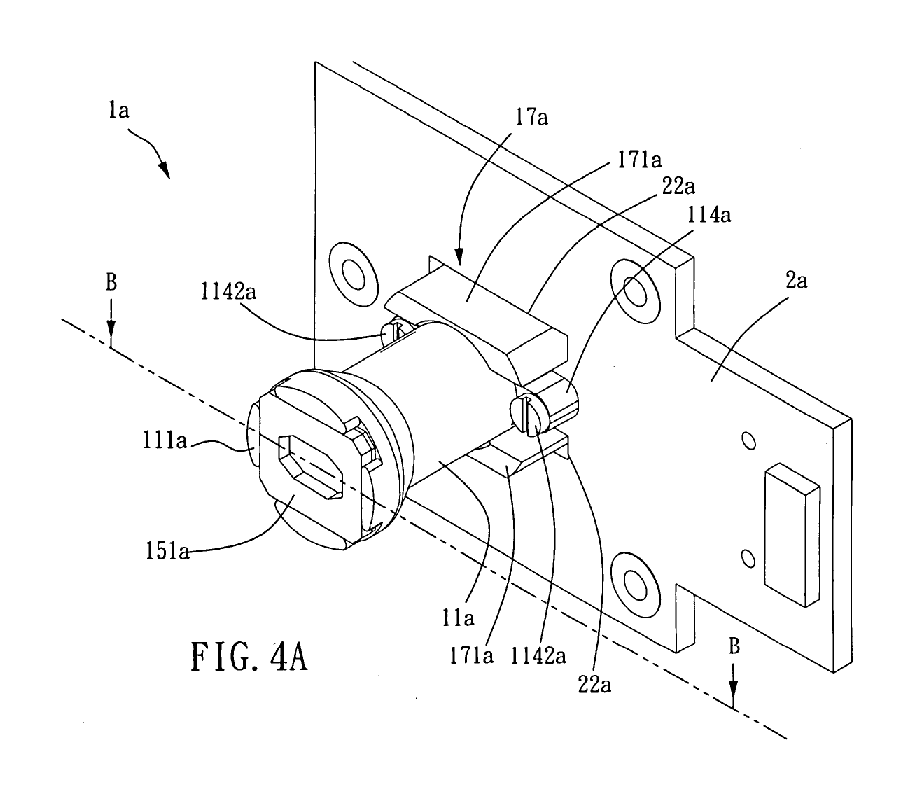

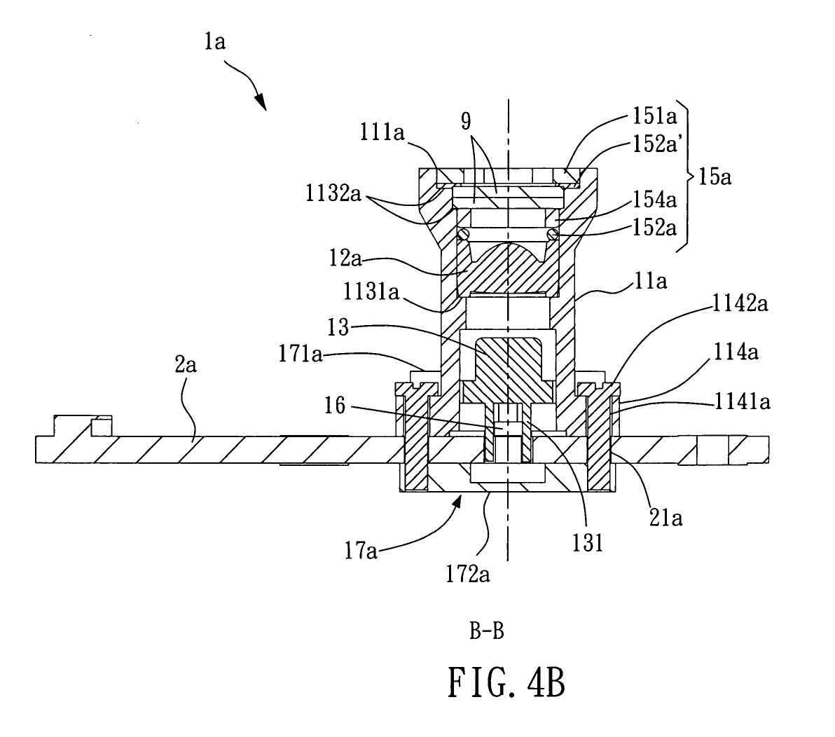

The second embodiment of the present invention is shown in FIGS. 3, 4A, and 4B. Referring to these FIGS., the main distinctions between the two embodiments lie in the fact that, in the second embodiment, the housing 14 is omitted, the temperature control plate 17a is different, and the image lens 9 of the laser module 1a is directly disposed inside the trumpet-shape front opening 111a of the main body 11a. A concave step 1131a is disposed inside the main body 11a such that the focusing lens 12a can be connected therein and also be aligned with the laser diode 13 in the main body 11a. In the second embodiment of the present invention, the circuit board 2a can be a printed circuit board with a pre-determined thickness to provide a further secure fixation for the main body 11a, in addition to the electrical connection between the laser diode 13 and the circuit board 2a.

A plurality of latching edges 1132a are disposed at the inner edge adjacent to the front opening 111a above the concave step 1131a in the main body 11a of the laser module 1a, so as to provide the mounting of the air-tight structure 15a for sealing the image lens 9 inside the main body 11a. The air-tight structure 15a further includes a clamp ring 151a, a plurality of rubber seal rings 152a, 152a′, and a retaining ring 154a. The rubber seal ring 152a is press-fitted upon the focusing lens 12a by the retaining ring 154a, and the image lens 9 is disposed on the retaining ring 154a. The other rubber seal ring 152a′ is then press-fitted inside the latching edges 1132a by the clamp ring 151a, such that the image lens 9 is securely fixed inside the main body 11a and aligned with the laser diode 13 through the hole of the retaining ring 154a and the focusing lens 12a.

The exterior of the main body 11a is provided with protruding and symmetrical fixed seats 114a, whose centers are provided with a screw hole 1141a, respectively, through which a screw 1142a can be inserted and then extend into a fixed pre-fabricated hole 21a on the circuit board 2a, such that the laser module la can be securely fixed to the circuit board 2a.

In the second embodiment of the present invention, the temperature control plate 17a is now U-shapes and is disposed on one surface of the circuit board 2a. The rear opening 112a of the man body 11a is positioned at the other surface of the circuit board 2a, as best shown in FIG. 4B. Two corresponding side walls 171a of the temperature control plate 17a are inserted through holes 22a pre-fabricated on the circuit board 2a, respectively, such that the two side walls 171a of the temperature control plate 17a are protruded out of the circuit board 2a and coupled with the two sides of the rear opening 112a of the main body 11a, as best shown in FIG. 4A. A base 172a is connected to the two side walls 171a of the temperature control plate 17a, and can be attached to the circuit board 2a such that the temperature control of the laser diode 13 can be carried out with the temperature control plate 17a.

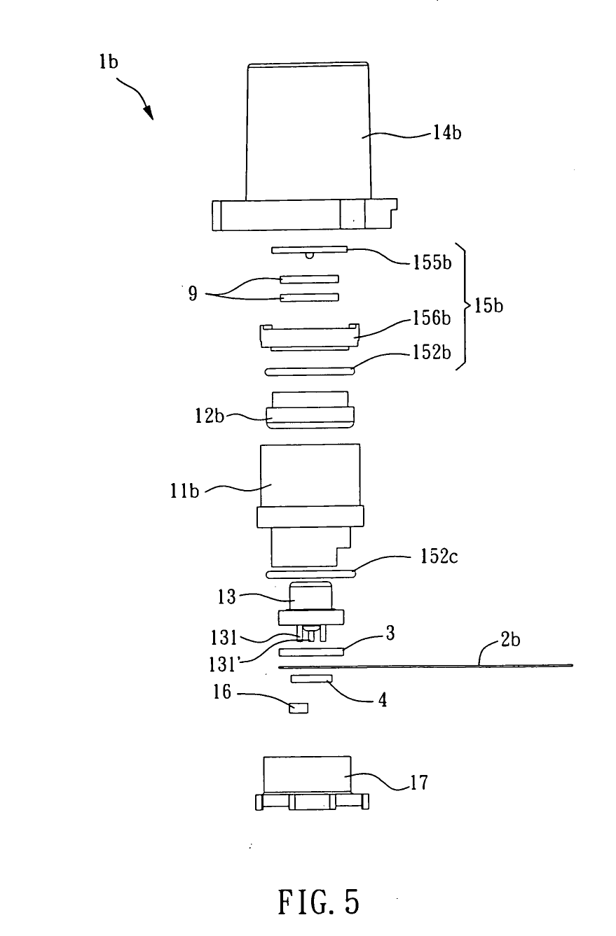

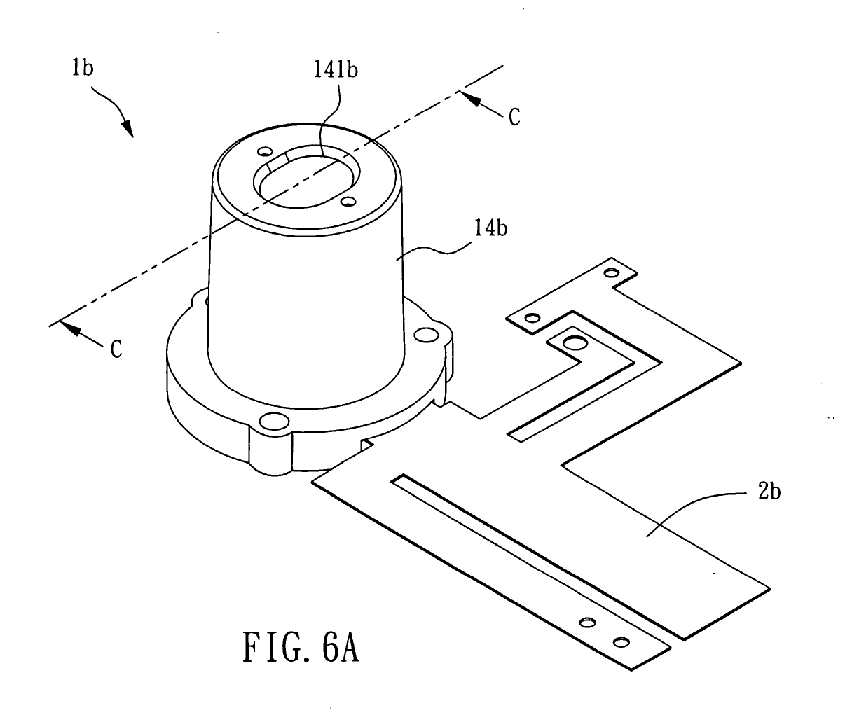

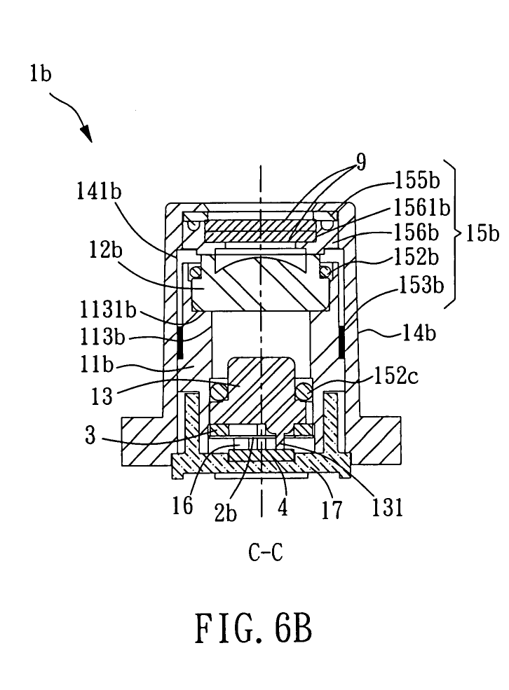

The third embodiment of the present invention is shown in FIGS. 5, 6A, and 6B. Referring to these FIGS., the distinctions between the third and the first embodiments lie primarily with the air-tight structure 15b, which differs from the air-tight structure 15 of the first embodiment. The air-tight structure 15b of the laser module 1b has a rubber seal ring 152b, an end seal 153b, a rubber pad 155b, and a stage 156b, and a further rubber seal ring 152c. When the focusing lens 12b is being connected to the inner wall 113b of the main body 11b, the focusing lens 12b is press-fitted and secured to the concave step 1131b on the inner wall 113b by the rubber seal ring 152b, which is inserted between the focusing lens 12b and the inner wall 113b. When the laser diode 13 is being positioned in the rear opening of the main body 11b, the rubber seal ring 152c disposed between the laser diode 13 and the main body 11b is employed to further seal the space between the laser diode 13 and the focusing lens 12b so as to further ensure the moisture proofing of the focusing lens 12b and the laser diode 13 inside the main body 11b.

Upon assembly, the rubber pad 155b is employed to press and fixedly secure the image lens 9 in an accommodating slot 1561b at the center of the stage 156b. The stage 156b (which is disposed on the focusing lens 12b) and the main body 11b are inserted into the cylindrical housing 14b in the order of from bottom to top, as shown in FIGS. 5 and 6B. Also, the gap between the main body 11b and the housing 14b is sealed with the end seal 153b such that the laser beam projected from the laser diode 13 travels through the focusing lens 12b, the image lens 9, and the through hole 141b to project outwardly.

Further, the temperature sensor 16 is positioned under the laser diode 13 and disposed under and electrically connected to the circuit board 2b. A ring thermal pad 3 is attached to the circuit board 2b, and the central space of the ring thermal pad 3 provides the space for the insertion of the conductive leads 131 and 131′ to be electrically connected to the circuit board 2b.

The space between the temperature control plate 17 and the circuit board 2b is occupied by another thermal pad 4, the two surfaces of which are attached to the temperature control plate 17 and the circuit board 2b, respectively. The thermal pad 4 is aligned with the thermal pad 3. Further, the temperature control plate 17 is coupled to the rear opening of the main body 11b such that the temperature of the laser diode 13 can be controlled by the temperature sensor 16 and the temperature control plate 17. In order words, the working temperature of the laser diode 13 is transferred from the circuit board 2b through the thermal pads 3 and 4 to the temperature control plate 17 so as to facilitate quick heat conduction.

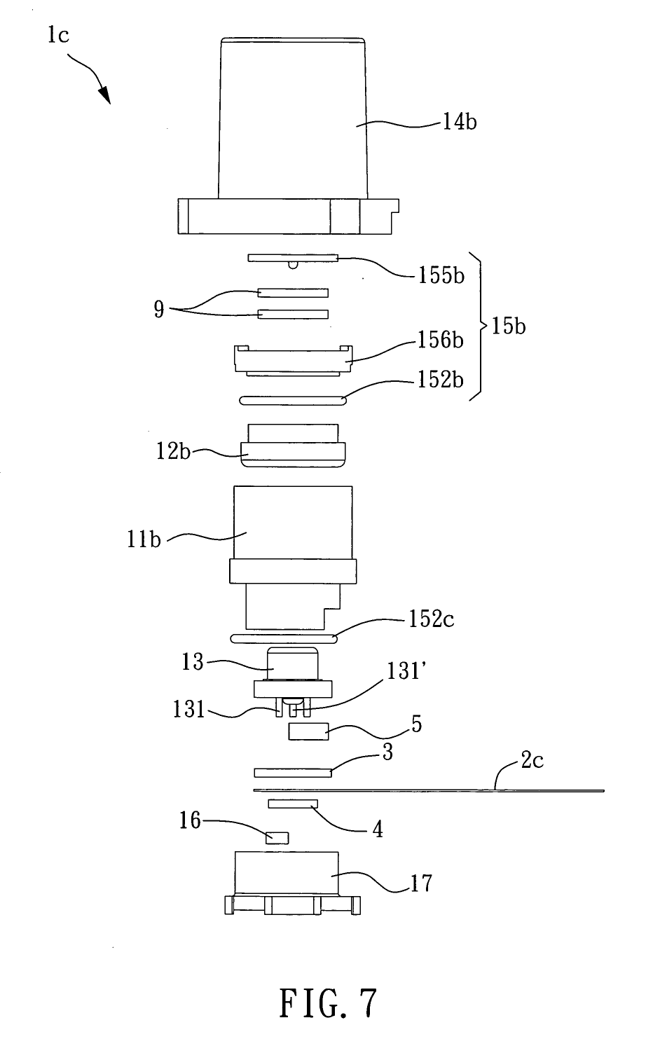

Referring to FIG. 7, which illustrates the fourth embodiment of the present invention, the primary distinction between the fourth and the third embodiments lie in the fact that laser module 1c further comprises a photodiode 5, which is disposed upon and electrically connected to the circuit board 2c, as well as positioned between the laser diode 13 and the circuit board 2c.

When the laser diode 13 is operating normally, the locations where a plurality of conductive leads 131 and 131′ are electrically connected to the laser diode 13 will emit laser beams. Consequently, the photodiode 5 disposed under the laser diode 13 and adjacent to the temperature sensor 16 can detect if the optical power of the laser light projected from the laser diode 13 is normal.

While the description above refers to particular embodiments of the present invention, it will be understood that many modifications may be made without departing from the spirit thereof.

What is claimed is:

1. A laser module capable of being connected onto a circuit board, comprising:
a main body having a front opening, a rear opening, an inner wall, and first and second protruding ribs disposed at the exterior and the inner wall of the main body, respectively;
a focusing lens positioned inside the front opening of the main body;
a laser diode having a first guide corresponding to the second protruding rib at the inner wall such that when the laser diode is inserted from the rear opening into the main body, the guide is aligned with the second protruding rib at the inner wall;
a housing having a second guide corresponding to the first protruding rib at the exterior of the main body such that when the housing is mounted on the main body, the second guide is aligned with the first protruding rib at the exterior of the main body; and
an image lens disposed in the housing and aligned with the focusing lens.

2. The laser module as defined in claim 1, further comprising:
a circuit board electrically connected to the laser diode and having a temperature sensor to detect the working temperature of the laser diode; and
a temperature control plate coupled to the rear opening of the main body and electrically connected with the circuit board to work with the temperature sensor to control the laser diode to operate within a pre-determined temperature range.

3. The laser module as defined in claim 2, further comprising two thermal pads positioned between the laser diode, the temperature control plate, and the circuit board.

4. The laser module as defined in claim 2, wherein the temperature control plate is a thermoelectric cooler, and the housing is made of heat-insulating plastics.

5. The laser module as defined in claim 1, wherein the image lens can be either a diffraction optical element (DOE) or a holographic optical element (HOD).

6. The laser module as defined in claim 1, wherein the housing includes a latching step near the front opening of the main body that connects of the image lens therein, and wherein the housing is made of heat-insulating plastics.

7. The laser module as defined in claim 6, further including an air-tight structure that seals the image lens inside the main body, the air-tight structure having a clamp ring, a plurality of rubber seal rings, and an end seal, wherein the clamp ring is employed to clamp one of the rubber seal rings and the image lens into the latching edge, another one of the rubber seal rings is employed to seal the gap between the focusing lens and the main body, and the end seal covers the gap between the external surface of the main body and the inner surface of the housing so as to seal the image lens inside the housing.

8. The laser module as defined in claim 1, further comprising a photodiode which is disposed upon and electrically connected to the circuit board, as well as positioned under the laser diode to detect the optical power of the laser diode.

9. The laser module as defined in claim 2, wherein the laser diode extends to form a plurality of conductive leads to be electrically connected to the circuit board, the conductive leads connected with the casing of the laser diode to form a copper pad along the base of the laser diode, with the temperature sensor straddling the copper pad so as to detect the temperature of the copper pad and further adjust the working temperature of the laser diode.

10. The laser module as defined in claim 1, further including an air-tight structure that seals the image lens inside the main body, the air-tight structure having a rubber pad, a rubber seal ring, an end seal, and a stage, wherein the rubber seal ring is inserted between the focusing lens and the inner wall, and the rubber pad is employed to press and fixedly connect the image lens into an accommodating slot at the center of the stage, and the stage which is disposed upon the focusing lens and the main body is further inserted into the housing, with the gap between the main body and the housing sealed with the end seal.

11. A laser module, comprising:
a main body having a front opening, a rear opening, and an inner wall;
a focusing lens fixed at the front opening of the main body;
a laser diode fixed at the rear opening of the main body;
a housing mounted around the exterior of the main body and enclosing the main body;
an image lens inside the housing and aligned with the focusing lens;
a circuit board electrically connected to the laser diode and having a temperature sensor to detect the working temperature of the laser diode; and
a temperature control plate coupled to the rear opening of the main body and electrically connected to the circuit board to work with the temperature sensor to control the laser diode to operate within the pre-determined temperature range.

12. The laser module as defined in claim 11, wherein:
the main body has first and second protruding ribs disposed at its exterior and its inner wall, respectively;
the laser diode has a first guide corresponding to the second protruding rib at the inner wall such that when the laser diode is inserted from the rear opening into the main body, the first guide is aligned with the second protruding rib at the inner wall; and
the housing has a second guide corresponding to the first protruding rib at the exterior of the main body such that when the housing is mounted to the main body, the second guide is aligned with the first protruding rib at the exterior of the main body.

13. The laser module as defined in claim 11, further comprising two thermal pads positioned between the laser diode, the temperature control plate, and the circuit board.

14. The laser module as defined in claim 11, wherein the temperature control plate is a thermoelectric cooler, and the housing is made of heat-insulating plastics.

15. The laser module as defined in claim 11, wherein the image lens can be either a diffraction optical element (DOE) or a holographic optical element (HOD).

16. The laser module as defined in claim 11, further including an air-tight structure that seals the image lens inside the main body, the air-tight structure having a clamp ring, a plurality of rubber seal rings, and an end seal, wherein the clamp ring is employed to clamp one of the rubber seal rings and the image lens into the front opening of the main body, another one of the rubber seal rings is employed to seal the gap between the focusing lens and the main body, and the end seal covers the gap between the external surface of the main body and the inner surface of the housing so as to seal the image lens inside the housing.

17. The laser module as defined in claim 11, further comprising a photodiode which is disposed upon and electrically connected to the circuit board, as well as positioned under the laser diode to detect the optical power of the laser diode.

18. A laser module capable of being connected onto a circuit board, comprising:
a main body having a front opening, a rear opening, and an inner wall;
a focusing lens connected in the front opening;
a housing mounted to the exterior of the main body and enclosing the main body, with one end of the housing corresponding to the focusing lens having a through hole and the other end having an opening to accommodate the insertion of the main body into the housing;
a laser diode press-fitted onto the inner wall of the main body from the rear opening of the main body and aligned with the focusing lens as well as electrically connected to the circuit board;
an image lens aligned with the focusing lens;
an air-tight structure to seal the image lens inside the housing;
a temperature sensor positioned under the laser diode as well as disposed on and electrically connected with the circuit board;
a temperature control plate positioned under the laser diode and the temperature sensor as well as coupled to the rear opening of the main body; and
a photodiode disposed upon and electrically connected with the circuit board as well as positioned under the laser diode to detect the optical power of the laser diode.

19. The laser module as defined in claim 18, wherein:
at the inner edge of the through hole of the housing is disposed with a latching step for connecting the image lens therein;
the housing is made of heat-insulating plastics; and
the air-tight structure comprises a clamp ring, a plurality of rubber seal rings, and an end seal;
wherein the clamp ring is employed to clamp one of the rubber seal rings and the image lens into the latching edge, another one of the rubber seal rings is employed to seal the gap between the focusing lens and the main body, and the end seal covers the gap between the external surface of the main body and the inner surface of the housing so as to seal the image lens inside the housing.

20. A laser module capable of being connected onto a circuit board, comprising:
a main body having a front opening, a rear opening, and an inner wall;
a focusing lens positioned inside the front opening;
a laser diode press-fitted onto the inner wall of the main body from the rear opening of the main body and aligned with the focusing lens, as well as electrically connected with the circuit board;
an image lens positioned inside the main body and aligned with the focusing lens; and
an air-tight structure that seals the image lens inside the main body in a manner to provide the focusing lens with a moisture-proof effect.

21. The laser module as defined in claim 20, further comprising a temperature sensor and a temperature control plate, with the temperature sensor positioned under the laser diode as well as disposed on and electrically connected with the circuit board, and wherein the temperature control plate is positioned under the laser diode and the temperature sensor, such that the temperature control plate controls the temperature of the laser diode.

22. The laser module as defined in claim 20, further comprising a housing mounted to and enclosing the exterior of the main body, with one end of the housing corresponding to the focusing lens and having a through hole and the other end of the housing having with an opening to accommodate the insertion of the main body into the housing, wherein the inner edge of the through hole of the housing has a latching step for the connection of the image lens therein, and wherein the housing is made of heat-insulating plastics.

23. The laser module as defined in claim 22, wherein the air-tight structure comprises a clamp ring, a plurality of rubber seal rings, and an end seal, with the clamp ring employed to clamp the rubber seal ring and the image lens into the latching edge, and wherein the end seal covers the gap between the external surface of the main body and the inner surface of the housing so as to seal the image lens inside the housing.

24. The laser module as defined in claim 21, wherein the temperature control plate is a thermoelectric cooler.

25. The laser module as defined in claim 20, wherein the image lens can be either a diffraction optical element (DOE) or a holographic Optical element (HOD), and the laser beam projected from the laser diode travels through the image lens to from a pre-determined image which is subsequently projected outward.

26. The laser module as defined in claim 20, further comprising a photodiode, which is disposed upon and electrically connected with the circuit board, as well as positioned under the laser diode, to detect the optical power of the laser diode.

27. The laser module as defined in claim 20, wherein the inner wall of the main body and the exterior of the laser diode are disposed, respectively, with a fitting structure that comprises a protruding rib and a guide, wherein the guide is inserted into the protruding rib on which the guide can be moved axially with respect to the main body, such that the focusing lens that is fixedly disposed in the laser diode and the main body can be moved to adjust focusing.

28. The laser module as defined in claim 22, wherein the exterior of the main body and the inner edge of the through hole of the housing are disposed, respectively, with a corresponding fitting structure that comprises a guide and protruding rib, wherein the, protruding rib is inserted into the guide on which the protruding rib can be moved axially with respect to the main body such that the main body can be inserted into the housing.

29. The laser module as defined in claim 21, wherein the laser diode extends to form a plurality of conductive leads to be electrically connected with the circuit board, wherein the conductive leads connected with the casing of the laser diode extend to form a copper pad along the base of the laser diode, and wherein the temperature sensor straddles the copper pad so as to detect the temperature of the copper pad and further adjust the working temperature of the laser diode.

30. The laser module as defined in claim 22, wherein the air-tight structure comprises a rubber pad, a rubber seal ring, an end seal, and a stage, with the rubber seal ring inserted between the focusing lens and the inner wall, and the rubber pad is employed to press and fixedly connect the image lens onto an accommodating slot at the center of the stage, wherein the stage disposed upon the focusing lens and the main body are further inserted into the housing, and the gap between the main body and the housing is sealed with the end seal such that the laser beam projected from the laser diode travels through the focusing lens, the image lens, and the through hole to project outward.
